(19) United States
(12) Patent Application Publication
(10) Pub. No.: US 2019/0017938 A1
(43) Pub. Date: Jan. 17, 2019

(54) DIFFRACTIVE BIOSENSOR

(71) Applicant: DR. JOHANNES HEIDENHAIN GmbH, Traunreut (DE)

(72) Inventors: Wolfgang Holzapfel, Obing (DE); Michael Kugler, St. Georgen (DE); Marco Schade, Traunstein (DE)

(21) Appl. No.: 16/009,218

(22) Filed: Jun. 15, 2018

(30) Foreign Application Priority Data
Jul. 12, 2017 (DE) 10 2017 211 910.1

(51) Int. Cl. G01N 21/77; G02B 6/42

(52) U.S. Cl. CPC G01N 21/7743; G01N 2201/088; G02B 6/4215

(57) ABSTRACT

A diffractive biosensor for selective detection of biomolecules includes a substrate and a flat waveguide disposed on the substrate. The waveguide has an optical grating configured to couple incident light into the waveguide such that the light is guided through the waveguide to a detection region located behind an edge of the waveguide. The in-coupling efficiency and intensity of the light arriving in the detection region are dependent on a surface coverage of the optical grating with the biomolecules to be detected. The optical grating has receptors for the biomolecules periodically arranged on the waveguide. The light incident on the optical grating is collimated.

### CROSS-REFERENCE TO PRIOR APPLICATION

Priority is claimed to German Patent Application No. DE 10 2017 211 910.1, filed on Jul. 12, 2017, the entire disclosure of which is hereby incorporated by reference herein.

### FIELD

The present invention relates to a diffractive biosensor. Such sensors are based on the adsorption of biomolecules to be detected onto a waveguide, the biomolecules forming a diffractive grating for coupling light into and out of the waveguide. The signal of a photodetector serves as a measure of the coverage of the biosensor surface with the biomolecules.

### BACKGROUND ART

From optics, waveguides are known which are disposed on a substrate and have an optical grating for in-coupling and out-coupling light. Such an optical grating may, for example, take the form of structures which are etched into the substrate or into the waveguide and thus are composed of the material of the substrate or of the waveguide. The grating period required is dependent on the wavelength of the light used and on the refractive index of the waveguide. Depending on the coupling angle, the grating period is in the range of the effective wavelength of the light in the waveguide. Typically, it is about half the vacuum wavelength of the light. Structures of such fineness are complex and costly to manufacture.

In the field of biosensors, there are also known gratings for coupling-in and coupling-out light which are composed of biological matter and act as receptors for the biomolecules to be analyzed. If such biomolecules accumulate on the receptors that are structured as a grating, the biomolecules form an optically effective grating. Such receptors structured as a grating, whether with or without adsorbed biomolecules, will hereinafter be referred to as “biogratings” or more simply as “gratings.” Since the diffraction efficiency of such a grating is dependent on the coverage of the grating surface with the biomolecules, a quantitative statement can be made about the surface coverage based on the intensity of the diffracted light measured by a detector.

WO 2015004264 A1 describes a diffractive biosensor where divergent light passes through a substrate and impinges on an optical grating for coupling light into a waveguide. The light propagating in the waveguide then strikes a grating which acts as an out-coupling grating. The coupled-out light is focused through the substrate onto a detector. The light intensity measured in the detector is a measure of the coverage of the out-coupling grating with the biomolecule to be analyzed. However, using two biogratings implies a very weak signal because of the two-fold weak coupling.

WO 2013107811 A1 describes a diffractive biosensor which uses a biograting and an in-coupling grating etched into the waveguide. However, due to the additional lithography step, this adds considerably to the complexity and cost of manufacturing such biosensors.

FIG. 2 of EP 0226604 B1 illustrates a diffractive biosensor where light incident through a substrate is coupled into a waveguide via an optical grating. The incident light propagates in the waveguide directly to a detector disposed at an edge of the waveguide. A separate out-coupling grating is not needed here. In this biosensor, the quantitative analysis of the biomolecules to be analyzed is based on a change in the refractive index of the medium above the optical grating. This change in the refractive index results in a change in the light intensity in the detector, which change is proportional to the concentration of the biomolecules. However, optical gratings of this kind, whose diffraction efficiency is influenced by a change in refractive index occurring only near the grating, are less suitable than the above-mentioned gratings where the diffracting grating is formed by adsorption of biomolecules to be analyzed. The reason for this is that the zero signal is large and that the two-dimensional application of the biomolecules on lines and spaces above the optical grating results in low sensitivity.

### SUMMARY

In an embodiment, the present invention provides a diffractive biosensor for selective detection of biomolecules. The diffractive biosensor includes a substrate and a flat waveguide disposed on the substrate. The waveguide has an optical grating configured to couple incident light into the waveguide such that the light is guided through the waveguide to a detection region located behind an edge of the waveguide. The in-coupling efficiency and intensity of the light arriving in the detection region are dependent on a surface coverage of the optical grating with the biomolecules to be detected. The optical grating has receptors for the biomolecules periodically arranged on the waveguide. The light incident on the optical grating is collimated.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows an embodiment with oblique light incidence;

FIG. 2 shows an embodiment with normal light incidence;

FIG. 3 shows an embodiment with a regular grating matrix and temporal multiplexing;

FIG. 4a shows an embodiment with gratings staggered in a matrix;

FIG. 4b shows an alternative embodiment, which has a regular grating matrix and spaced-apart foci;

FIG. 5 shows an embodiment with a matrix of gratings having straight grating lines;

FIG. 6 shows an embodiment with a detector in the detection region;

FIG. 7 shows an embodiment with a cylinder lens in front of the detector;

FIG. 8 shows an embodiment with a spherical or aspherical lens in front of the detector;

FIG. 9 shows an embodiment with an optical fiber;

FIG. 10 shows an embodiment with an aperture stops for filtering scattered light;

FIG. 11 shows an embodiment with an aperture stop in an intermediate Fourier plane;

FIG. 12 shows an embodiment with a mirror layer for increasing the in-coupling efficiency.

### DETAILED DESCRIPTION

Embodiments of the present invention provide an optimized design of a diffractive biosensor which is inexpensive to manufacture, yet allows efficient detection of biomolecules to be analyzed.

According to an embodiment, a diffractive biosensor for selective detection of biomolecules is provided, the biosensor having a substrate and a flat waveguide disposed on the substrate. Incident light is coupled by an optical grating into the waveguide and guided to a detection region located behind an edge of the waveguide, the in-coupling efficiency, and thus the intensity of the light arriving in the detection region, being dependent on a surface coverage of the grating with the biomolecules to be detected. The grating has receptors for the biomolecules periodically arranged on the waveguide, and the light incident on the grating is collimated.

One option is that the optical grating is a linear grating and transmits collimated light into the waveguide toward the detection region, and that a first lens between the edge of the waveguide and the detection region focuses the light onto the detection region. However, it is preferred that the optical grating have curved grating lines and focus the light toward the detection region.

Thus, embodiments of the present invention provides a diffractive biograting having preferably curved lines which bioselectively couples collimated incident excitation light into a planar waveguide and at the same time focuses it onto a detection region at or near the edge of the waveguide. In the case of straight grating lines, a lens must focus the light emerging in collimated form at the edge.

The signal measured by a photodetector serves as a measure of the surface coverage of the adsorbed biomolecules. To this end, a planar waveguide is mounted to a suitable substrate. The refractive index of the waveguide must be greater than that of the substrate. A diffractive biograting forms on the surface of the waveguide by adsorption of biomolecules along defined lines. Thus, to produce the biosensor, suitable receptors for the biomolecules to be detected must be deposited in structured form on the waveguide to form a grating.

For the gratings having curved lines, it holds that the sub-beams emanating from all grating locations should constructively interfere at the focus (i.e., in the detection region). This results in the following equation for the xⱼ, yⱼ coordinates of these grating lines:

$${x}_{j} ( {y}_{j} ) = \frac{{fN}_{eff}^{2} + n λ sin ( α ) ( j + {j}_{0} ) + {N}_{eff} \sqrt{\begin{matrix}{( λ ( j + {j}_{0} ) + nf sin ( α ) )}^{2} - \\ {y}_{j}^{2} ( {N}_{eff}^{2} - {n}^{2} {sin}^{2} ( α ) )\end{matrix}}}{{N}_{eff}^{2} - {n}^{2} {sin}^{2} ( α )}$$

For normal incidence (α=0°), this equation is simplified as follows:

$${x}_{j} ( {y}_{j} ) = f + \sqrt{\frac{{λ}^{2}}{{N}_{eff}^{2}} {( j + {j}_{0} )}^{2} - {y}_{j}^{2}}$$

Here, N_{eff} denotes the effective refractive index of the guided mode in the waveguide, n the refractive index of the medium from which the light beam is incident, λ the wavelength of the light in vacuum, f the focal length of the grating in the x-y plane, j an inter counting index, j₀ an arbitrarily selected integer offset, and a the angle of the incident light as measured from the normal to the surface of the waveguide, the angle of incidence being counted positively in a positive x-direction running from the detection region toward the grating.

In the general case, the grating structure is formed by a set of ellipses; the normal distance A between adjacent lines is nearly equidistant: at y=0, the distance is Λ=λ/(N_{eff}-n*sin(α)); for y≠0, the normal distance decreases slightly due to the curved line pattern. In the special case where α=0°, the grating structure is simplified to a set of concentric circles about a point located at a distance f, and the normal distance between adjacent lines is Λ=λ/N_{eff} and thus strictly equidistant for all y. This equidistant arrangement of the lines is particularly advantageous because it significantly simplifies the lithographic manufacturing process. The biograting may be produced lithographically by patterning a layer of suitable receptors.

The biograting is illuminated with coherent, collimated excitation light (e.g., the light of a laser). The use of collimated excitation light has the advantage that only the angle between the biograting and the incident light beam has to be correctly aligned. This is much easier to accomplish than to position, with accuracy in all three spatial directions, a divergent light source (e.g., a fiber end) at the focus of a suitably configured biograting for coupling in divergent light. In addition, due to the angular spectrum, the use of divergently incident light always requires a continuously varying spacing of the grating lines, while an equidistant grating is sufficient for collimated light.

In the presence of adsorbed biomolecules on the receptor surface, the excitation light is bioselectively coupled into the waveguide, where the coupled-in signal light is guided by total internal reflection. Due to the curvature of the grating lines, the signal light is focused onto a point in the detection region or near the edge of the waveguide. A constriction in cross-sectional area of the light perpendicularly to the plane of the waveguide is intrinsically given by the waveguide itself.

A waveguide edge having a sufficiently low roughness and suitable for coupling out the light can be produced, for example, by laser cutting or sawing followed by polishing.

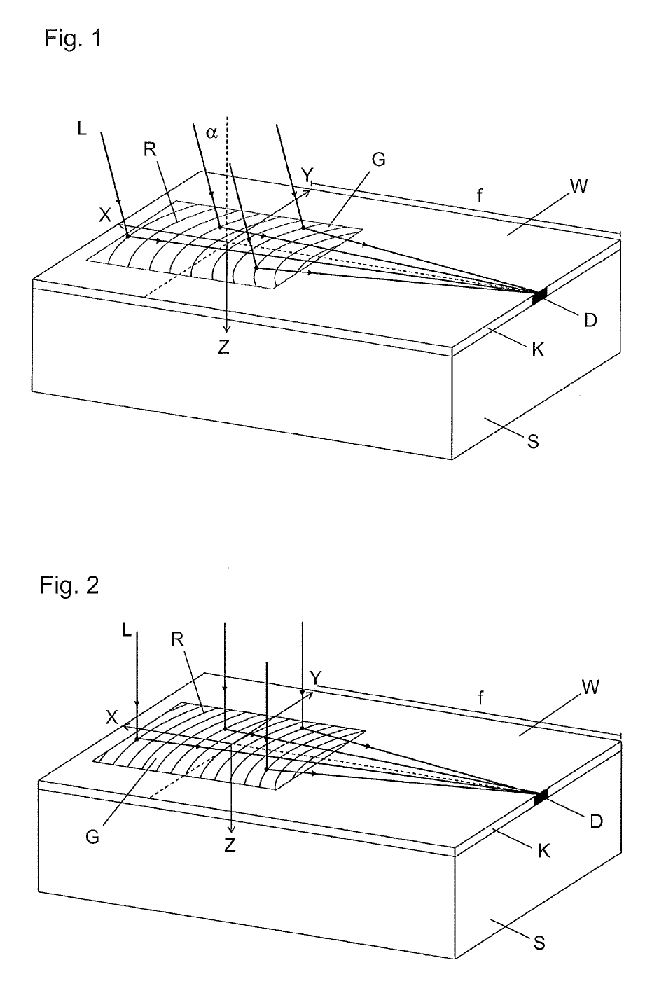

FIG. 1 shows a first embodiment of a diffractive biosensor. A flat waveguide W is disposed on a substrate S in the x-y plane. The refractive index of waveguide W must be greater than the refractive index of substrate S. Suitable materials for substrate S would be glass or a polymer, such as polyethylene with a refractive index of about 1.5. Materials that may be used for waveguide W include Ta₂O₅, Si₃N₄, SiOₓN_{y}, TiO₂ and SiC with refractive indices of 2.12, 2.04, 1.5 to 2.1, 2.58 and 2.63, respectively.

A grating G of linearly structured receptors R is arranged on waveguide W. Receptors R are capable of adsorbing the biomolecules to be detected and thereby forming an optically effective grating G for coupling light L into waveguide W. Thus, grating G is a biograting in accordance with the definition given above.

Grating G focuses collimated incident light L onto a detection region D located at or near an edge K of waveguide W. As will be illustrated further below, light L may be detected here or passed on to a detector. Focal length f of grating G is chosen to be equal to the distance of grating G from detection region D.

In this first embodiment, the angle of incidence a of light L is selected to be greater than 0° (shallow incidence). This has the advantage that the distance between adjacent lines of receptors R is larger than in the case of α=0°, which simplifies the lithographic manufacturing process. Furthermore, the condition for the coupling of light L into waveguide W is satisfied only in the forward direction, so that in contrast to the case of α=0°, in-coupling in the backward direction is suppressed.

A modified embodiment as compared to FIG. 1 would be an angle of incidence of less than 0° (acute incidence); i.e., with incident light beams L whose directional component in the x-direction is reversed compared to FIG. 1. While this modification requires a reduction in distance Λ=λ/(N_{eff}−n*sin(α)) between adjacent lines, it has the advantage that incident light cannot be scattered toward detection region D located at edge K.

FIG. 2 shows another exemplary embodiment where the angle of incidence is selected to be α=0° (normal incidence). If additional in-coupling of light L in the backward direction can be tolerated, then this embodiment is particularly advantageous because a grating structure with strictly equidistant circular segments about the focal point of grating G is obtained. This simplifies lithography because in the case of an equidistant grating, the zero order of the required lithography phase mask can be completely suppressed for a given illumination wavelength, which maximizes the contrast between lines and spaces.

Following are exemplary embodiments that use multiple gratings G on one biosensor to enable testing of multiple samples or to allow one or more samples to be tested for different biomolecules using a single biosensor. This can significantly speed up certain analysis tasks.

These exemplary embodiments use multiplexing with a two-dimensional array composed of m rows of gratings arranged side by side parallel to out-coupling edge K and n columns perpendicular thereto, which is possible because gratings G interact only slightly with light L in waveguide W. Because of this, signal light L which is bioselectively coupled in at a grating G can propagate through a subsequent grating G in the same column without significantly influencing the intensity of the signal light. Even a monolayer of biomolecules (e.g., of TSH, a typical representative of the biomolecules to be detected) would only have a diffraction efficiency of about 10⁻⁴; however, the realistic coverage of biosensors, and thus the diffraction efficiency, is typically several orders of magnitude lower.

The multiplexing can be implemented in different ways, each requiring a corresponding suitable detection variant at edge K at which light L is coupled out. Basically, signal-carrying light L produced by different gratings G can be separated at edge K in three different ways:

a) in time; i.e., by illuminating the individual gratings G sequentially,
b) in the spatial domain by placing the focal points of the individual gratings G at different locations on waveguide edge K,
c) by direction by selecting the solid angle into which a grating G emits such that it differs from the other gratings G;
and combinations of these three options.

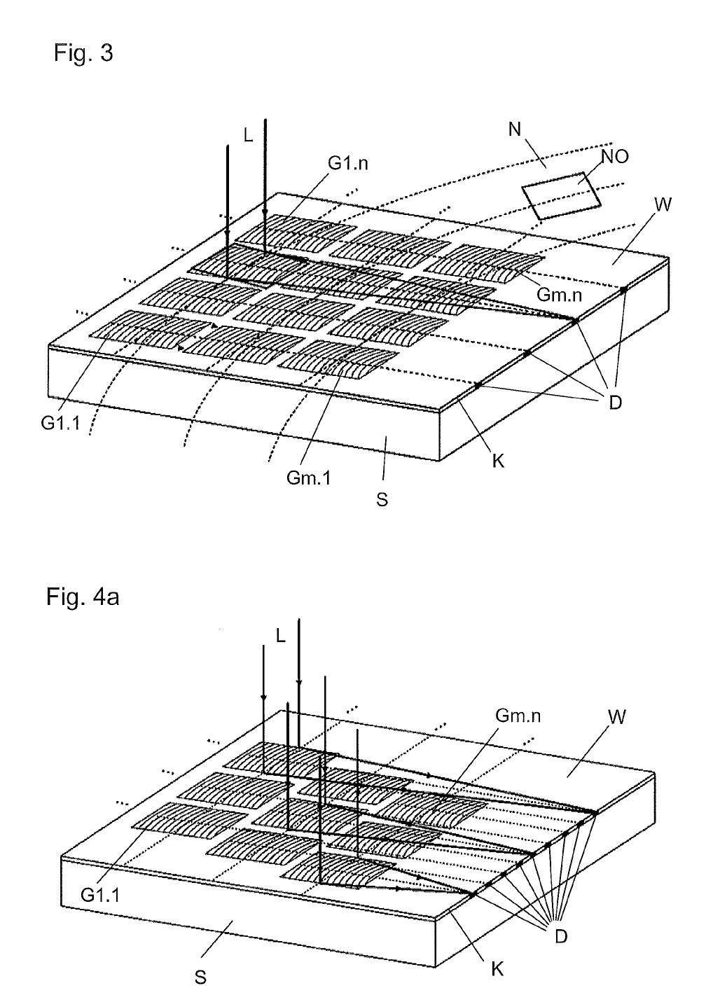

A third embodiment according to variant a), shown in FIG. 3, consists of an array of m×n gratings Gm.n in m rows and n columns in a regular pattern, where all m gratings Gm.n of a column are focused onto the same point on edge K. Sequential illumination may be accomplished using, for example, an aperture plate N (Nipkow disk) having suitable m openings NO of the size of a grating Gm.n, which illuminate gratings Gm.n row by row, so that a detector at edge K receives light L from different gratings Gm.n successively. It is equally possible to shade off all gratings Gm.n except one at a time using a transmissive LCD element. An advantage of temporal multiplexing is that no scattered light from other gratings Gm.n or non-covered locations on the waveguide W can contribute to the signal of the currently illuminated grating Gm.n because no other locations are illuminated. Also, the cost and complexity of detection is reduced because only one detector must be provided for a narrow location of waveguide edge K, while other embodiments may require imaging of the entire edge. Generally, the time required for the measurement is essentially determined by the reaction dynamics of the adsorption of the biomolecules to be detected, which takes place in time scales of minutes. The integration time for detecting the in-coupled signal is of little consequence here, so that the time required for sequential measurement of different gratings Gm.n can be tolerated.

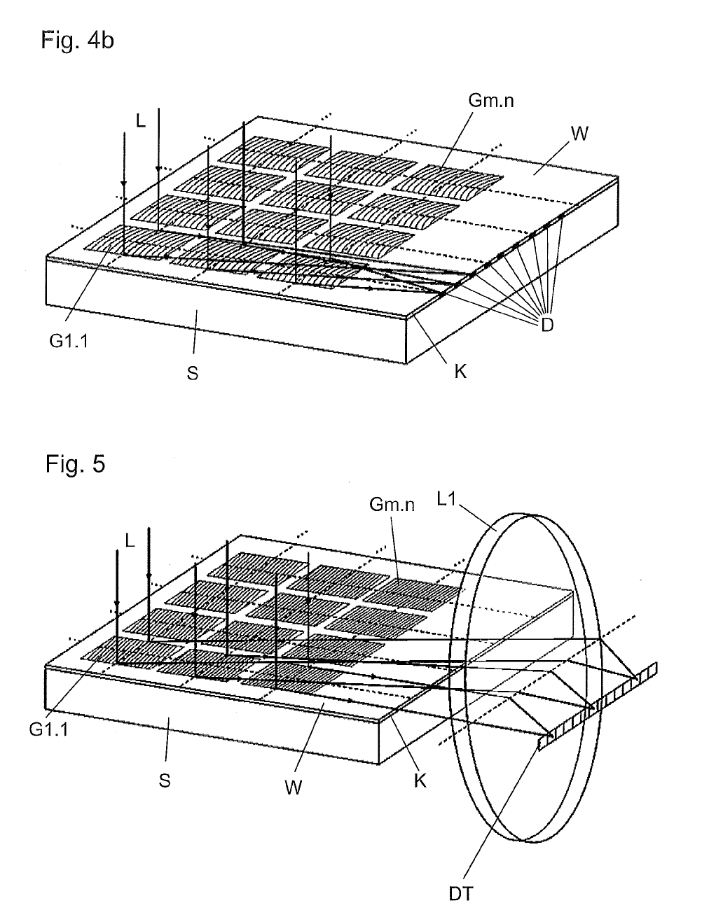

FIGS. 4a and 4b show variants of a fourth embodiment in which light L is separated in the spatial domain according to variant b). In FIG. 4a, the gratings Gm.n in the individual rows are slightly staggered relative to each other, so that light L impinges on respective, spatially separated detection regions D. The detector used may be a line array of light-sensitive elements arranged along edge K. The advantage of this embodiment is that the grating structure remains mirror-symmetric about the respective optical axis, which is beneficial for optimizing the lithography mask.

In contrast, in the variant according to FIG. 4b, a modified design of gratings Gm.n makes it possible for each grating to aim at a different focal point or detection region D located apart from all other focal points. The advantage of this embodiment is that the regular pattern of gratings Gm.n is maintained and that all gratings Gm.n of a column lie on a line perpendicular to substrate edge K. This makes it easier, for example, to locate gratings Gm.n during the manufacturing steps, during quality control and during the application of samples. The displacement of the foci of the individual gratings Gm.n away from the original optical axis x=0 requires a trivial modification of the formula for determining the grating lines (see above) which, like the original formula, is based by the requirement that the sub-beams emanating from all grating locations should constructively interfere at the focus.

For both variants of the fourth exemplary embodiment according to FIGS. 4a and 4b, it holds that, because it is possible to select identical focal lengths and incoupling directions, all gratings Gm.n of a row may be identical in structure and thus may be structured successively using the same mask, on which only one such structure must be present.

FIG. 5 shows, as a fifth exemplary embodiment, third variant c) according to the above enumeration of options for separating light L at edge K.

An embodiment according to variant c) is an m×n array of gratings Gm.n were the gratings couple the light into waveguide W in different directions without focusing it in the spatial domain. This special case, in which the focal length of gratings Gm.n approaches infinity, results in linear gratings Gm.n which are particularly easy to produce. In this exemplary embodiment, the grating lines of gratings Gm.n extend in different, angularly offset directions. A parallel light beam propagates from each grating Gm.n toward edge K. By focusing the light beams propagating in different direction by means of a lens L1 placed behind edge K and positioning a line detector DT in its focal plane (Fourier plane), light L of different gratings Gm.n can be detected separately.

It can be shown that variants b) and c) are basically equivalent in terms of the signal-to-noise ratio because their mode volume (“space requirement”) in the in this case two-dimensional position-direction phase space is always the same due to the conservation of etendue. The advantage of such arrays is that, in contrast to temporal multiplexing, they eliminate the need for a Nipkow disk or a device for selectively illuminating individual gratings through LCD shading or a similar device.

As for the detection of the in-coupled signal light L at waveguide edge K, the image formation, the sensor geometry and the filtering of the light may be implemented differently. A few examples will be illustrated below.

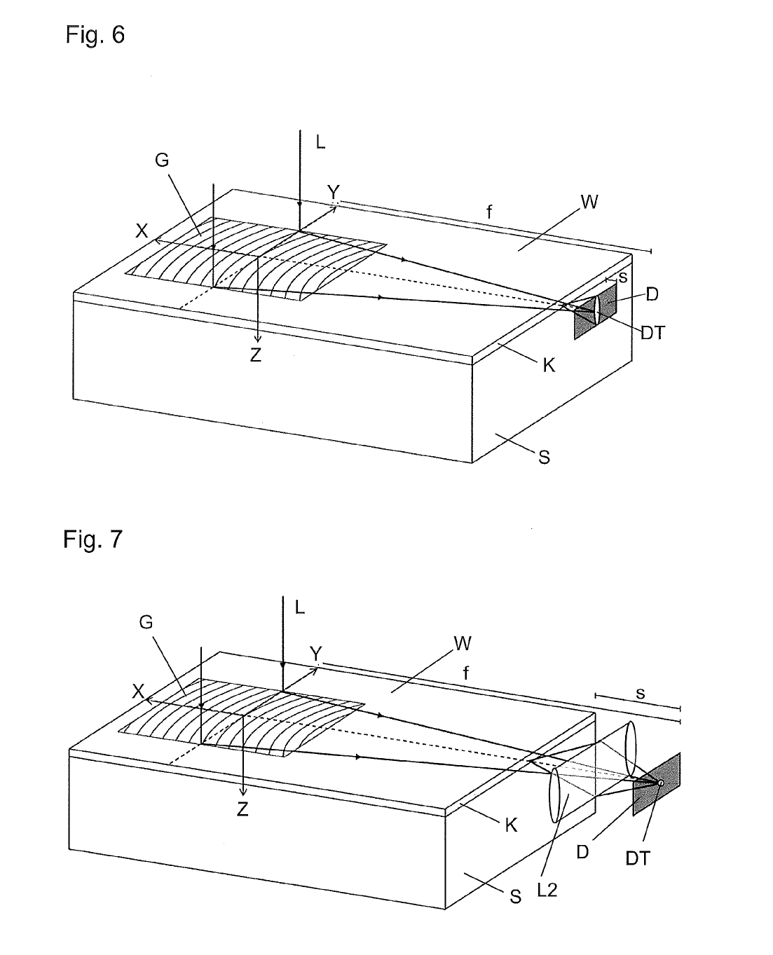

FIG. 6 illustrates lensless imaging onto detection region D. In this variant, focal length f of grating G is selected such that emerging light L is not focused directly onto the edge, but slightly behind it onto a light-sensitive detector DT, which is spaced from edge K of waveguide W by a minimum possible distance s (of, for example, between 10 and 100 micrometers). The advantage of this variant resides in the simple, robust and cost-effective design because no additional optical components are needed. In addition, since the numerical aperture of this imaging optical system is nearly NA=1, a possible roughness of edge K is irrelevant. The disadvantage of this embodiment is that the light emerging form waveguide W diverges in the z-direction, thus widening the beam and resulting in less efficient noise suppression in the z-direction along distance s between edge and detector DT (which should therefore be minimized).

Therefore, in the exemplary embodiment of FIG. 7, a cylinder lens L2 is inserted to image the edge onto the detector. The light L emerging divergently in the z-direction is focused by cylinder lens L2 onto detector DT, which increases the light intensity on detector DT. For this purpose, distance s between edge K of waveguide W and detector DT is matched to focal length of the cylindrical lens in the z-direction (for example, such that s is equal to four times the focal length), and focal length f of grating G is selected such that the focus is still on detector DT in the y-direction.

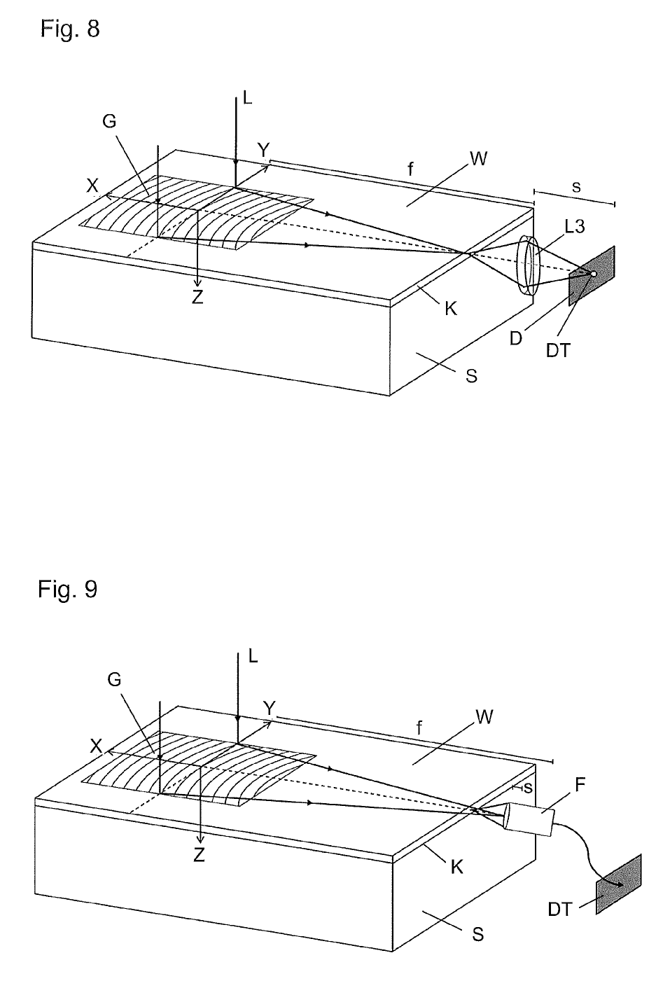

In the embodiment shown in FIG. 8, a spherical or aspherical lens L3 is used. Here, focal length f of grating G is selected such that signal light L is focused onto edge K of the waveguide. Spherical or aspherical lens L3 images edge K onto detector DT. The advantage of this embodiment is the filtering of light L. Scattered light at an angle greater than the numerical aperture of the image-forming spherical or aspherical lens L3 cannot impinge upon detector DT.

In connection with such an image-forming lens L3, it is particularly advantageous to use a two-dimensional detector array (camera) for detection (see further below). Furthermore, the signal may be directionally filtered in a simple manner using an imaging optical system having an aperture stop in an intermediate Fourier plane, as will also be explained in greater detail below.

In another embodiment, shown in FIG. 9, signal light L is guided to detector DT by an optical fiber F. Here, focal length f of grating G is selected such that emerging light L is focused in the y-direction onto the end of an optical fiber, which end is spaced from edge K of waveguide W by a minimum possible distance s (of, for example, between 10 and 100 micrometers). This embodiment is similar to the above-discussed lensless embodiment of FIG. 6, but the guidance of light in fiber F offers the additional advantage that detector DT may be spatially separated from substrate S, which allows greater flexibility in the arrangement of the components of a biosensor. Again, in order to remedy the disadvantages of the light emerging divergently in the Z direction, this embodiment may be combined with the above-discussed cylinder lenses (FIG. 7) or spherical/aspherical lenses (FIG. 8).

For the sake of clarity, the embodiments shown in FIGS. 6-9 regarding the imaging of signal light L emerging at edge K are each discussed only for one grating G, but, in the case of multiplexing with m×n gratings Gm.n (FIGS. 3, 4a, 4b, 5), may easily be extended to corresponding 1×n arrays (lens array, fiber array, detector array). This means that the imaging options illustrated in FIGS. 6-9 are repeated for each of the n columns having m gratings Gm.n. Alternatively, it is also possible to use only one optical train for the entire image field. The optical elements used (e.g., lenses, fibers, waveguides) may be composed of either suitable glasses or plastics or combinations thereof.

In all exemplary embodiments, the following holds for detectors DT: The sensor geometry may be embodied as a single pixel, a one-dimensional pixel array or a two-dimensional pixel array.

The single-pixel embodiment, which may be implemented, for example, as a photodiode, is particularly advantageous in order to obtain a simple, inexpensive detection unit. The use of a single detector pixel is also possible in connection with multiplexing of an m×m array of gratings Gm.n which are illuminated sequentially and all point to the same focal point.

A second embodiment is the use of a one-dimensional line array of detectors DT which are arranged along the out-coupling edge K of waveguide W, so that the light of the n columns of gratings Gm.n impinges on different, spatially separated detector pixels. In this connection, it is also possible to use more than n pixels, and to perform spatial filtering in an analyzing software.

Another option is the use of a two-dimensional detector array. As already mentioned earlier, this variant lends itself in particular for use in combination with an image-forming spherical or aspherical lens L3, because in this way a camera is obtained which images edge K of waveguide W. This makes it possible to detect the focus of emerging signal light L and, at the same time, to obtain information about the scattered light background in the y- and z-directions, and thus to spatially filter the signal at detector DT.

As mentioned earlier herein, it is advantageous to separate a possibly arising scattered light background from the signal light to be detected. While a structured photodetector (pixel array) already intrinsically causes spatial filtering of the detector signal, it may be advantageous to additionally filter signal light L to suppress scattered light.

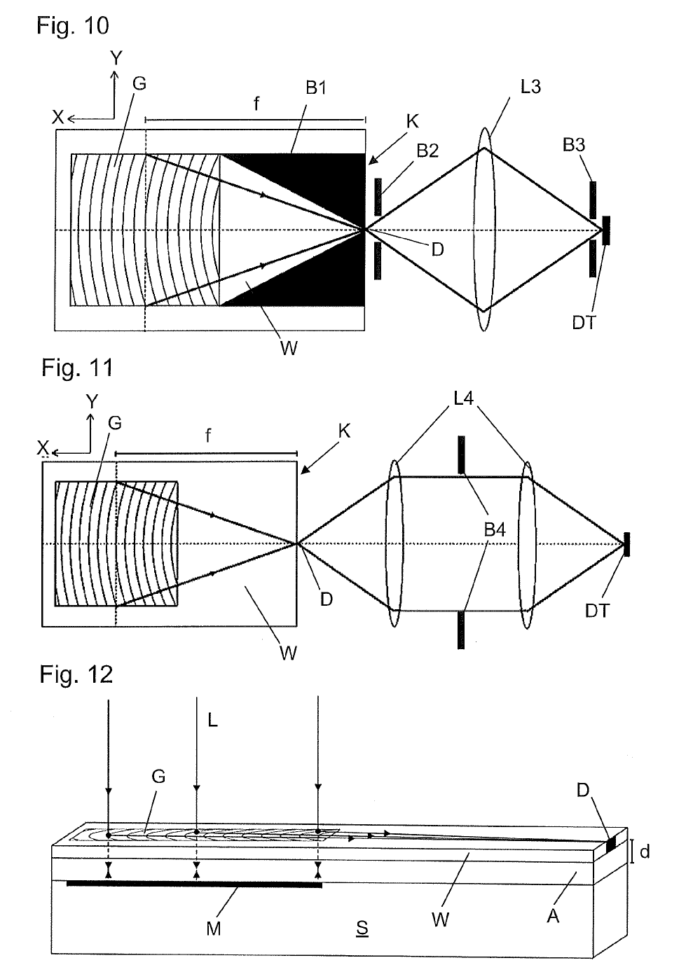

A possible embodiment is filtering in the spatial domain, as illustrated in FIG. 10. One may just simply place one or two spatial-domain aperture stops B2, B3 at the positions indicated in FIG. 10; i.e., between edge K and image-forming lens L3 and/or between lens L3 and detector DT. In this way, the aperture of detector DT is masked, so that a smaller region of edge K of waveguide W is imaged.

It is also possible to integrate an aperture stop B1 into the biosensor. For this purpose, an additional, preferably absorbent layer (e.g., chromium) may be deposited on waveguide W. This layer prevents total internal reflection in waveguide W, thus coupling out and at the same time absorbing the light to be cut off. In this connection, it should be noted that such an aperture stop B1 is no longer a pure spatial-domain aperture stop because it also influences a portion of the angular spectrum.

FIG. 11 shows another possible embodiment for the suppression of scattered light, here by filtering in the Fourier space. An imaging optical system L4 including a plurality of lenses and an aperture stop B4 in an intermediate Fourier plane provides a convenient means for directionally filtering signal light L.

With regard to the exemplary embodiments illustrated hereinbefore, it should be added that illumination may not only be from the medium side (from above), but also from the substrate side (from below).

FIG. 12 shows a further exemplary embodiment where the in-coupling efficiency of grating G is significantly improved. For this purpose, a planar reflective layer (mirror layer) M is provided which is deposited on the side of waveguide W facing away from the incident light at a given distance d which is defined by a suitable transparent spacer layer A. This reflective layer may be either a metallic or a dielectric (e.g., a distributed Bragg reflector (DBR)) mirror M. Mirror M has the function of reflecting the light that has been transmitted through grating G in the first pass back to grating G to make it interact therewith a second time.

To this end, distance c between grating G and mirror M has to be selected such that the two sub-beams undergo constructive interference, thereby improving the in-coupling efficiency and thus increasing the signal in detector DT by a factor of four

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A diffractive biosensor for selective detection of biomolecules, the diffractive biosensor comprising:
a substrate; and
a flat waveguide disposed on the substrate and having an optical grating configured to couple incident light into the waveguide such that the light is guided through the waveguide to a detection region located behind an edge of the waveguide, wherein:
in-coupling efficiency and intensity of the light arriving in the detection region are dependent on a surface coverage of the optical grating with the biomolecules to be detected,
the optical grating has receptors for the biomolecules periodically arranged on the waveguide, and
the light incident on the optical grating is collimated.

2. The diffractive biosensor as recited in claim 1, wherein the optical grating is a linear grating and is configured to transmit collimated light into the waveguide toward the detection region, the diffractive biosensor further comprising a first lens arranged between the edge of the waveguide and the detection region and configured to focus the light onto the detection region.

3. The diffractive biosensor as recited in claim 1, wherein the optical grating has curved grating lines and is configured to focus the light toward the detection region.

4. The diffractive biosensor as recited in claim 1, further comprising a detector disposed in the detection region, or further comprising optical elements configured to project the light from the detection region onto a detector.

5. The diffractive biosensor as recited in claim 4, wherein the optical element is an optical fiber.

6. The diffractive biosensor as recited in claim 1, wherein a plurality of optical gratings are disposed on the waveguide and are configured to guide the light spatially separately and/or separately in time to one or more detection regions.

7. The diffractive biosensor as recited in claim 6, wherein the optical gratings are configured such that the light coupled into the waveguide by one of the optical gratings passes through regions of the waveguide which carry further optical gratings.

8. The diffractive biosensor as recited in claim 6, further comprising a rotating aperture plate having one or more openings and configured such that the light impinges through the one or more openings on the optical gratings in time-spaced sequence so as to achieve a separation in time.

9. The diffractive biosensor as recited in claim 6, wherein the optical gratings are configured to guide the light in different directions to spaced-apart detection regions so as to achieve a separation in space.

10. The diffractive biosensor as recited in claim 1, wherein the diffractive biosensor is configured such that the light falls through one or more aperture stops along a path of light from the optical grating to the detection region or a detector and the aperture stops blocking incident scattered light.

11. The diffractive biosensor as recited in claim 1, wherein the diffractive biosensor is configured such that the light is incident thereon from a side of the diffractive biosensor facing the waveguide, the diffractive biosensor further comprising a mirror layer disposed between the waveguide and the substrate and configured to reflect light which is not coupled into the waveguide back to the optical grating.

12. The diffractive biosensor as recited in claim 11, further comprising a spacer layer disposed between the waveguide and the mirror layer, the spacer layer having a thickness selected such that light impinging on the optical grating for a first time and light reflected by the mirror layer interfere constructively at the optical grating.
